(19) United States
(12) Patent Application Publication
(10) Pub. No.: US 2023/0422060 A1
(43) Pub. Date: Dec. 28, 2023

(54) METHOD AND PLMN FOR CONTROLLING DISASTER AREA FOR DISASTER ROAMING SERVICE IN WIRELESS NETWORK

(71) Applicant: SAMSUNG ELECTRONICS CO., LTD., Suwon-si, Gyeonggi-do (KR)

(72) Inventors: Aman AGARWAL, Bangalore (IN); Kailash Kumar JHA, Bangalore (IN); Lalith KUMAR, Bangalore (IN); Samiran BHOWMIK, Bangalore (IN); Mahmoud WATFA, Bangalore (IN)

(21) Appl. No.: 18/251,274

(22) PCT Filed: Dec. 22, 2021
(86) PCT No.: PCT/KR2021/019621

§ 371 Date: May 1, 2023

(30) Foreign Application Priority Data
Dec. 24, 2020 (IN) 202041056399
Dec. 9, 2021 (IN) 202041056399

(51) Int. Cl. H04W 24/04; H04W 60/04; H04W 8/02

(52) U.S. Cl. CPC H04W 24/04; H04W 60/04; H04W 8/02; H04W 84/042

(57) ABSTRACT

Embodiments herein provide a method for controlling disaster area for disaster roaming service by a UE (100). The method includes detecting a disaster condition associated with a first PLMN (200a) that is associated with a first service provider. Further, the method includes sending a registration request to a second PLMN (200b) for the disaster roaming service. The second PLMN (200b) is associated with a second service provider and is available in a disaster area covered by the first PLMN (200a). Further, the method includes receiving a TAI list from the second PLMN (200b). The TAI list includes a set of tracking areas associated with the disaster area covered by the second PLMN (200b). Further, the method includes camping on the second PLMN (200b) for the disaster roaming service in the set of tracking areas indicated in the TAI list during the disaster condition with the first PLMN (200a).

### CROSS-REFERENCE TO RELATED APPLICATIONS

This application is 371 of International Patent Application No. PCT/KR2021/019621 filed on Dec. 22, 2021, which is based on Indian Patent Application No. 202041056399 filed on Dec. 24, 2020, and Indian Patent Application No. 202041056399 filed on Dec. 9, 2021, the disclosure of which is incorporated by reference herein in its entirety.

### BACKGROUND

### 1. Field

The present disclosure relates to a wireless network and more specifically related to a method and a public land mobile network (PLMN) for controlling a disaster area for a disaster roaming service in the wireless network.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FOAM) and sliding window superposition coding (SWSC) as an advanced coding modulation (ACM), and filter bank multi carrier (FBMC), non-orthogonal multiple access(NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In general, the purpose of a Mobile Information and Network Technologies (MINT) is to minimize interruption of service to users of a User Equipment (UE) when a wireless network to which these users are subscribed cannot provide service due to a disaster such as e.g. a fire, by enabling the users to obtain service on other networks, while at the same time protecting those other networks from congestion.

When a disaster condition applies, all User Equipment's (UEs) of a Public Land Mobile Network (PLMN) subject to disaster (PLMN D) that are located in an area where the Disaster Condition applies will look for another PLMN (e.g., PLMN A, PLMN C) in that area and attempt to register on it to obtain service. This could cause a large number of UEs to migrate from the PLMN subject to disaster to another PLMN, and attempt registration at around the same time, leading to signaling overload in the other PLMN due to the massive influx of roamers.

Methods to avoid congestion in other PLMNs not affected by disaster scenario are as follows—
1. If the UE determines that the PLMN D has “Disaster Condition”, determines that a PLMN A can accept “Disaster Inbound Roamers” from the PLMN D, the UE could try registration on such PLMN A.
2. But since large of number of the UE of PLMN D could attempt registration on PLMN A due to disaster, the PLMN A could get congestion (due to inbound roamers as well as its own UEs).
3. There could be other PLMNs available in that area which could also provide service to Disaster Inbound Roamers from the PLMN D. But there is no method to distribute the subscribers of PLMN D between the PLMNs able to accept Disaster Inbound Roamers of PLMN D and avoid congestion on one particular PLMN ID.

In an example, Forbidden PLMNs(FPLMN) are operators from which the UE does not get service because that a roaming FPLMN does not have an agreement to provide service with a home PLMN. However, during the disaster situation for example, when an gNB of the HPLMN are not functional due to earth quake etc., the HPLMN may allow FPLMN to provide service to the UE. But, the FPLMN for sure is going to charge high value to the HPLMN for such services. Given getting service from the FPLMN during disaster situation is costly affair HPLMN wants to restrict this service to its UEs only in disaster area. In other areas FPLMN should not provide service to the UE. Thus there is need for a mechanism in which the FPLMN restricts the service to the UE only in the disaster area based on guidance from the HPLMN. Here the HPLMN can be generalized for any PLMN facing the disaster situation and was potential normal service provider to the UE.

Thus, it is desired to address the above mentioned disadvantages or other shortcomings or at least provide a useful alternative.

### SUMMARY

The principal object of the embodiments herein is to provide a method and a public land mobile network (PLMN) for controlling a disaster area for a disaster roaming service in the wireless network.

Another object of the embodiments herein is to avoid congestion in other Public Land Mobile Networks (PLMNs) not affected by disaster scenario.

Accordingly, the embodiment herein is to provide a method for controlling disaster area for disaster roaming service in a wireless network. The method includes detecting, by a UE, a disaster condition associated with a first PLMN, where the first PLMN is associated with a first service provider. Further, the method includes sending, by the UE, a registration request to a second PLMN for the disaster roaming service. The second PLMN is associated with a second service provider and is available in a disaster area covered by the first PLMN. Further, the method includes receiving, by the UE, a Tracking Area Identity (TAI) list from a second PLMN in response to the registration requesting a Non-access stratum (NAS) message, registration accept. The TAI list includes a set of tracking areas associated with the disaster area covered by the second PLMN. Further, the method includes camping, by the UE, on the second PLMN for the disaster roaming service in the set of tracking areas indicated in the TAI list during the disaster condition with the first PLMN.

In an embodiment, the registration request is rejected by the second PLMN indicating a suitable cause to the UE, if the registration request to the second PLMN for the disaster roaming service is received outside disaster area determined by the second PLMN or the disaster roaming service is not provided to the first PLMN by second PLMN.

In an embodiment, further, the method includes receiving, by the UE, a change in the disaster area detected by the second PLMN. Further, the method includes receiving, by the UE, an updated TAI list from the second PLMN in a NAS message, Configuration update command, where the updated TAI list comprises an updated set of tracking areas with the disaster condition covered by the second PLMN. Further, the method includes camping, by the UE, on the second PLMN for the disaster roaming service in the updatedset of tracking areas indicated in the updated TAI list during the disaster condition with the first PLMN.

Accordingly, the embodiment herein is to provide a method for controlling disaster roaming service in a wireless network. The method includes receiving, by a second PLMN, a disaster area covered by a first PLMN, where the first PLMN is associated with a first service provider, and wherein the second PLMN is associated with a second service provider and is available in the disaster area covered by the first PLMN. Further, the method includes receiving, by the second PLMN, a registration request for the disaster roaming service from a UE associated with the first PLMN. Further, the method includes generating, by the second PLMN, a TAI list. The TAI list comprises a set of tracking areas associated with the disaster area covered by the second PLMN. Further, the method includes allocating, by the second PLMN, the TAI list to the UE for the disaster roaming service from the second PLMN in NAS message, registration accept, during the disaster condition with the first PLMN.

In an embodiment, the method further includes detecting, by the second PLMN, a change in the areas associated with the disaster area associated with the first PLMN. Further, the method includes generating, by the second PLMN, an updated TAI list. The updated TAI list comprises an updated set of tracking areas associated with the disaster area covered by the second PLMN. Further, the method includes allocating, by the second PLMN, the updated TAI list to the UE, in NAS message, Configuration update command.

In an embodiment, generating, by the second PLMN, the TAI list includes mapping, by the second PLMN, the disaster area covered by the first PLMN to Tracking Area Code (TAC) of the second PLMN, and generating, by the second PLMN, the TAI list based on the mapping.

Accordingly, the embodiment herein is to provide a UE for controlling disaster roaming service in a wireless network. The UE includes a disaster roaming service controller connected to a memory and a processor. The disaster roaming service controller is configured to detect a disaster condition associated with a first PLMN, wherein the first PLMN is associated with a first service provider. The disaster roaming service controller is configured to send a registration request to a second PLMN for the disaster roaming service. The second PLMN is associated with a second service provider and is available in a disaster area covered by the first PLMN. The disaster roaming service controller is configured to receive a TAI list from a second PLMN in response to the registration request, in a Non-access stratum (NAS) message, registration accept. The TAI list comprises a set of tracking areas associated with the disaster area covered by the second PLMN. Further, the disaster roaming service controller is configured to camp on the second PLMN for the disaster roaming service in the set of tracking areas indicated in the TAI list during the disaster condition with the first PLMN.

Accordingly, the embodiment herein is to provide a second PLMN for controlling disaster roaming service in a wireless network. The second PLMN includes a disaster roaming service controller connected to a memory and a processor. The disaster roaming service controller is configured to receive a disaster area covered by a first PLMN. The first PLMN is associated with a first service provider. The second PLMN is associated with a second service provider and is available in the disaster area covered by the first PLMN. Further, the disaster roaming service controller is configured to receive a registration request for the disaster roaming service from a UE associated with the first PLMN. Further, the disaster roaming service controller is configured to generate a TAI list. The TAI list comprises a set of tracking areas associated with the disaster area covered by the second PLMN. Further, the disaster roaming service controller is configured to allocate the TAI list to the UE for the disaster roaming service from the second PLMN in a NAS message, registration accept during the disaster condition with the first PLMN.

The PLMN ID part of list of “forbidden PLMNs” is forbidden PLMN(FPLMN).

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

According to an embodiment of the disclosure, the UE can be provided a disaster roaming service during the disaster condition with the first PLMN.

Further, according to an embodiment of the disclosure, the updated TAI list including the updated set of tracking areas with the disaster condition can be provided to the UE.

Further, according to an embodiment of the disclosure, it will be minimized congestion caused by disaster roaming of a PLMN providing the disaster roaming service.

### BRIEF DESCRIPTION OF THE DRAWINGS

This method is illustrated in the accompanying drawings, throughout which like reference letters indicate corresponding parts in the various figures. The embodiments herein will be better understood from the following description with reference to the drawings, in which:

FIG. 1 is an overview of a wireless network in which a PLMN controls a disaster area for a disaster roaming service, according to an embodiment as disclosed herein;

FIG. 2 shows various hardware components of a UE, according to an embodiment as disclosed herein;

FIG. 3 shows various hardware components of a PLMN, according to an embodiment as disclosed herein;

FIG. 4 is a flow chart illustrating a method, implemented by the UE, for controlling the disaster area for the disaster roaming service in the wireless network, according to an embodiment as disclosed herein;

FIG. 5 is a flow chart illustrating a method, implemented by the PLMN, for controlling the disaster area for the disaster roaming service in the wireless network, according to an embodiment as disclosed herein;

FIG. 6 is a signaling diagram illustrating a scenario of congestion control in other PLMNs not affected by a disaster method, according to the embodiments as disclosed herein; and

FIG. 7 is signaling diagram illustrating a scenario of a VPLMN to provide disaster inbound roamer UE's location to a HPLMN for verification, according to the embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a method for controlling disaster area for disaster roaming service in a wireless network. The method includes detecting, by a UE, a disaster condition associated with a first public land mobile network (PLMN), where the first PLMN is associated with a first service provider. Further, the method includes sending, by the UE, a registration request to a second PLMN for the disaster roaming service. The second PLMN is associated with a second service provider and is available in a disaster area covered by the first PLMN. Further, the method includes receiving, by the UE, a Tracking Area Identity (TAI) list from a second PLMN in response to the registration request, in a NAS message, registration accept. The TAI list includes a set of tracking areas associated with the disaster area covered by the second PLMN. Further, the method includes camping, by the UE, on the second PLMN for the disaster roaming service in the set of tracking areas indicated in the TAI list during the disaster condition with the first PLMN.

As part of registration procedure, when UE initiates registration with the PLMN-A, an AMF allocates the TAI list (registration area) only in the area of disaster. So that if UE moves out of the TAI list, the UE will trigger registration and the AMF will reject such request from the UE. This takes care that only disaster is served by FPLMN and in another area this PLMN-A is treated as FPLMN.

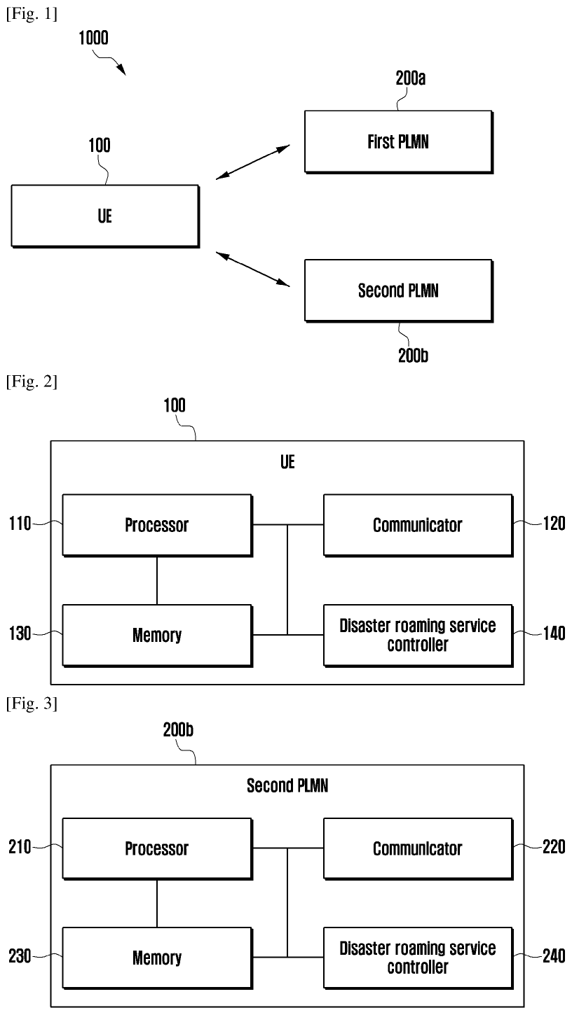

Referring now to the drawings and more particularly to FIGS. 1 through 7, where similar reference characters denote corresponding features consistently throughout the figures, there are shown preferred embodiments.

FIG. 1 is an overview of a wireless network (1000) in which a PLMN (200b) controls a disaster area for a disaster roaming service, according to an embodiment as disclosed herein. In an embodiment, the wireless network (1000) includes a UE (100), a first PLMN (200a) and a second PLMN (200b). The wireless network (1000) can be, for example, but not limited to a 2G network, a 3G network, a 4G network, a 5G network. The UE (100) can be, for example, but not limited to a laptop, a desktop computer, a notebook, a relay device, a Device-to-Device (D2D) device, a vehicle to everything (V2X) device, a smartphone, a tablet, an immersive device, an internet of things (IoT) device or the like. The UE (100) is communicated with the first PLMN (200a) and the second PLMN (200b) through a wired means and/or wireless means.

In an embodiment, the UE (100) is configured to detect a disaster condition associated with the first PLMN (200a). The first PLMN (200a) is associated with a first service provider. Based on the detection, the UE (100) is configured to send a registration request to the second PLMN (200b) for the disaster roaming service. The second PLMN (200b) is associated with a second service provider and is available in a disaster area covered by the first PLMN (200a). In response to the registration request, the UE (100) is configured to receive a TAI list from the second PLMN (200b), in a NAS message, registration accept. The TAI list includes a set of tracking areas associated with the disaster area covered by the second PLMN (200b). Further, the UE (100) is configured to camp on the second PLMN (200b) for the disaster roaming service in the set of tracking areas indicated in the TAI list during the disaster condition with the first PLMN (200a).

In an embodiment, the registration request is rejected by the second PLMN (200b) indicating a suitable cause to the UE (100), if the registration request to the second PLMN (200b) for the disaster roaming service is received outside disaster area determined by the second PLMN (200b) or the disaster roaming service is not provided to the first PLMN (200a) by second PLMN (200b).

Further, the UE (100) is configured to receive a change in the disaster area detected by the second PLMN (200b). Based on the detection, the UE (100) is configured to receive an updated TAI list from the second PLMN (200b), in a NAS message, Configuration update command. The updated TAI list includes an updated set of tracking areas with the disaster condition covered by the second PLMN (200b). Further, the UE (100) is configured to camp on the second PLMN (200b) for the disaster roaming service in the updatedset of tracking areas indicated in the updated TAI list during the disaster condition with the first PLMN (200a).

The conventional methods provide a congestion control in other PLMNs not affected by disaster scenario, detailed steps are as follows:
1. If the UE (100) determines that the PLMN D has “Disaster Condition” and determines that PLMN A can accept “Disaster Inbound Roamers” from PLMN D, the UE (100) could try registration on such PLMN A.
2. But since large of number of the UE (100) of the PLMN D could attempt registration on the PLMN A due to disaster, the PLMN A could have congestion (due to inbound roamers as well as its own UEs).
3. Current Congestion reject causes are not valid in such scenarios. Because the UE (100) will remain registered with PLMN A though it may not attempt for any service.
4. This would delay service for the Disaster affected UE (100).

Unlike to the conventional methods and systems, the proposed method provides congestion control in other PLMNs not affected by disaster scenario as follows:
1. If the inbound roamer attempts registration on the PLMN A (PLMN not affected by disaster and accepting inbound roamers of PLMN D) and if the PLMN A is already congested or it determines based on subscription or the local configuration or based on information from PLMN D that it should not provide service to the UE (100) for e.g. PLMN D is not the PLMN with disaster condition supported by PLMN A, then the PLMN A can reject the UE registration through any of the NAS(e.g. registration reject message) or AS signaling message using specific 5GMM cause #XXX “Network Congestion” or “Disaster service not provided” or “(PLMN with disaster condition not allowed).”. The name of reject cause can vary but purpose is same.
2. The PLMN A can also include the target PLMN id (any other PLMN which is not affected by disaster and accepting inbound roamers of PLMN D during disaster OR the VPLMN or the HPLMN) to user along with the reject cause.
3. The PLMN A can also provide estimated non availability duration of this PLMN which provides reject to the UE (100), thus the UE (100) should not attempt on this PLMN-A for provided time duration for disaster bound services. After which the UE (100) is allowed to re-attempt registration on PLMN A. if timer value is not provided by the network, the UE (100) will start the timer with implementation dependent time. All such PLMN—As which provided this reject cause can be stored in the list and those PLMNs are not attempted by the UE (100) to register for disaster roaming service as described for the decided duration of time by the UE (100). The UE (100) shall perform PLMN selection and should attempt for registration on some other PLMNs to receive “disaster roaming services”.
4. The UE (100) can then prioritize such PLMNs over others and hence reduce the time wasted in attempting other PLMNs which won't provide service to the UE (100). If no PLMN IDs were provided the UE (100) should attempt for registration on some other PLMNs to receive “disaster roaming services”.
5. The congestion on the PLMNs not affected by disaster and accepting inbound roamers of PLMN D could be reduced.
6. The UE (100) would be able to get faster service using the PLMN id included along with the reject cause.

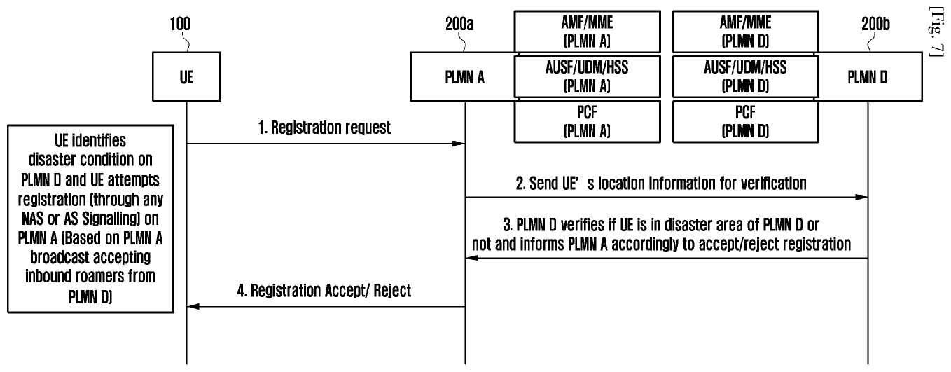

In the proposed scenario, the PLMN D is subject to disaster and PLMN A and PLMN C are alive and not subject to disaster and providing services to disaster affected UE's of PLMN D. The FIG. 6 explains the scenario in detailed way.

In the conventional methods if the UE (100) is not able to receive service from all the PLMNs available in the area, then the UE (100) will see and determine if any PLMN is ready to provide disaster based situation service to the UE (100). Let us say the PLMN-A is broadcasting or indicating (through the AS or the NAS based signaling) that it provides disaster situation services to the PLMN-D subscribers or Inbound roamers. With this indication the UE (100) may attempt for registration on PLMN-A assuming PLMN-D has faced disaster and may be PLMN-A will provide service to the UE (100). This increases unnecessary signaling load on the PLMN-A.

The conventional methods provide the VPLMN to provide disaster inbound roamer UE's location to the HPLMN for verification as follows:
1. If the UE (100) determines that the PLMN D has “Disaster Condition” and determines that the PLMN A can accept “Disaster Inbound Roamers” from the PLMN D, the UE (100) could try for registration (through any NAS or AS signaling) on the PLMN A.
2. The registration should only be allowed if the UE (100) is in the disaster area of the PLMN D and PLMN A should not accept registration for such UE outside disaster area.
3. There is no way currently for PLMN D to ensure and regulate that PLMN A doesn't provide service to its disaster-prone UE outside disaster area may be for policy or charging issues.

Unlike to the conventional methods, referring to the FIG. 7 consider a proposed method, the VPLMN to provide disaster inbound roamer UE's location to HPLMN for verification, the methods are as follows:
1. If the UE (100) determines that PLMN D has “Disaster Condition” and determines that PLMN A can accept “Disaster Inbound Roamers” from the PLMN D, the UE (100) could try for registration (through any NAS or AS signaling) on the PLMN A.
2. If the VPLMN determines that any such UE (100) is trying for registration in the disaster condition, it shall provide the UE's location information (via any message) to UE's HPLMN for verification if the UE (100) is in the HPLMN or the PLMN D's disaster location or not.
3. The PLMN D verifies if the UE (100) is in disaster area of PLMN D or not and informs PLMN A accordingly to accept/reject registration. Based on this information PLMN A shall accept or reject UE's registration (via any NAS or AS signaling). The PLMN A can use a new reject cause for this purpose provided as part of NAS or AS message, which indicates to the UE (100) that current UE location does not require disaster based services and UE should attempt to get normal services. i.e. there is no disaster situation for the serving operator in that area or at the time. The UE (100) then attempts to receive normal service by performing PLMN selection procedure.

In the above scenario, the PLMN D is subject to disaster and PLMN A is alive and not subject to disaster and providing services to disaster affected UE's of PLMN D.

Another conventional methods provides TAI list to the UE by AMF it should consider the disaster area into account. Methods are as follows:
1. If the UE (100) determines that PLMN D has “Disaster Condition” and determines that PLMN A can accept “Disaster Inbound Roamers” from the PLMN D, the UE (100) could try for registration (through any NAS or AS signaling) on the PLMN A.
2. After the UE (100) is successfully registered on the PLMN A, the UE (100) should be provide only those TACs as a part of TAI list which are in the disaster area of PLMN D and shall not be provided other TAC which doesn't cover disaster area.

Therefore the proposed solution is provided to handle the above mentioned conditions.

Unlike to the conventional methods, the TAI list to the UE (100) by the AMF it should consider the disaster area into account are as follows:
1. If the UE (100) determines that PLMN D has “Disaster Condition” and determines that PLMN A can accept “Disaster Inbound Roamers” from the PLMN D, the UE (100) could try for registration (through any NAS or AS signaling) on the PLMN A.
2. The serving AMF shall consider the disaster area of PLMN D as provided by PLMN D or CBE and provide only those Tracking Area Code(s) (TAIs) which are part of disaster area of PLMN D to Disaster inbound roamers of PLMN D as a part of TAI list to the UE (100) in the NAS message like registration accept or UE configuration update.
3. The serving AMF can internally map the disaster area provided by PLMN D or CBE to TAC(s) to be provided to disaster inbound roamers of PLMN D.

FIG. 2 shows various hardware components of the UE (100), according to an embodiment as disclosed herein. In an embodiment, the UE (100) includes a processor (110), a communicator (120), a memory (130) and a disaster roaming service controller (140). The processor (110) is coupled with the communicator (120), the memory (130), and the disaster roaming service controller (140).

The disaster roaming service controller (140) is configured to detect the disaster condition associated with the first PLMN (200a). The first PLMN (200a) is associated with the first service provider. Based on the detection, the disaster roaming service controller (140) is configured to send the registration request to the second PLMN (200b) for the disaster roaming service. The second PLMN (200b) is associated with the second service provider and is available in the disaster area covered by the first PLMN (200a). In response to the registration request, the disaster roaming service controller (140) is configured to receive the TAI list from the second PLMN (200b), in the NAS message, registration accept. The TAI list includes the set of tracking areas associated with the disaster area covered by the second PLMN (200b). Further, the disaster roaming service controller (140) is configured to camp on the second PLMN (200b) for the disaster roaming service in the set of tracking areas indicated in the TAI list during the disaster condition with the first PLMN (200a).

Further, the disaster roaming service controller (140) is configured to receive the change in the disaster area detected by the second PLMN (200b). Based on the detection, the disaster roaming service controller (140) is configured to receive the updated TAI list from the second PLMN (200b) in the NAS message, Configuration update command. The updated TAI list includes the updated set of tracking areas with the disaster condition covered by the second PLMN (200b). Further, the disaster roaming service controller (140) is configured to camp on the second PLMN (200b) for the disaster roaming service in the updatedset of tracking areas indicated in the updated TAI list during the disaster condition with the first PLMN (200a).

The disaster roaming service controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator(120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 3 shows various hardware components of the PLMN (200), according to an embodiment as disclosed herein. In an embodiment, the PLMN (200) includes a processor (210), a communicator (220), a memory (230) and a disaster roaming service controller (240). The processor (210) is coupled with the communicator (220), the memory (230), and the disaster roaming service controller (240).

The disaster roaming service controller (240) is configured to receive the disaster area covered by the first PLMN (200a), where the first PLMN (200a) is associated with the first service provider. The second PLMN (200b) is associated with the second service provider and is available in the disaster area covered by the first PLMN (200a). Further, the disaster roaming service controller (240) is configured to receive the registration request for the disaster roaming service from the UE (100) associated with the first PLMN (200a). Further, the disaster roaming service controller (240) is configured to generate the TAI list. The TAI list is generated by mapping the disaster area covered by the first PLMN (200a) to the TAC of the second PLMN (200b). The TAI list includes the set of tracking areas associated with the disaster area covered by the second PLMN (200b). Further, the disaster roaming service controller (240) is configured to allocate the TAI list to the UE (100) for the disaster roaming service from the second PLMN (200b) in a NAS message, registration accept during the disaster condition with the first PLMN (100a).

Further, the disaster roaming service controller (240) is configured to detect the change in the areas associated with the disaster area associated with the first PLMN (200a). Further, the disaster roaming service controller (240) is configured to generate an updated TAI list, wherein the updated TAI list comprises the updated set of tracking areas associated with the disaster area covered by the second PLMN (200b). Further, the disaster roaming service controller (240) is configured to allocate the updated TAI list to the UE (100), in a NAS message, Configuration update command.

The disaster roaming service controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator(220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the PLMN (200) but it is to be understood that other embodiments are not limited thereon. In other embodiments, the PLMN (200) may include less or more number of components. Further, the labels or names of the components are used only for illustrative purpose and does not limit the scope of the invention. One or more components can be combined together to perform same or substantially similar function in the PLMN (200).

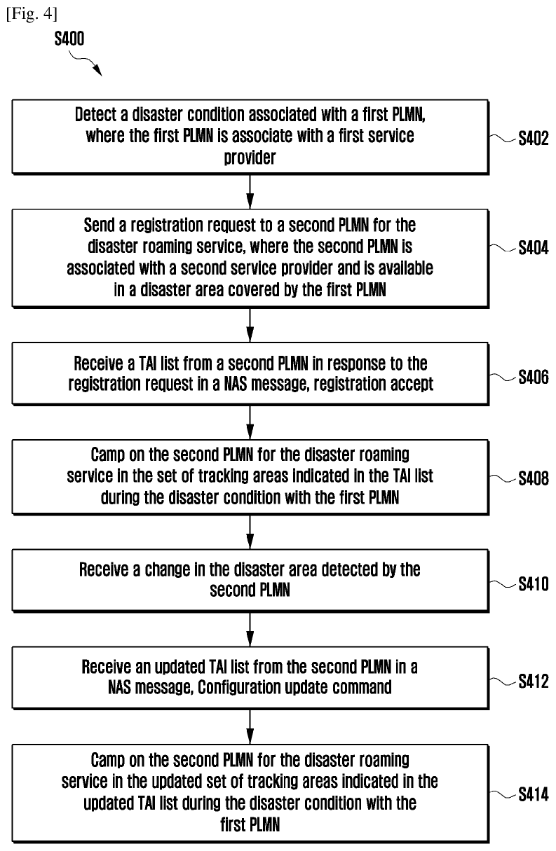

FIG. 4 is a flow chart (S400) illustrating a method, implemented by the UE (100), for controlling the disaster area for the disaster roaming service in the wireless network (1000), according to an embodiment as disclosed herein. The operations (S402-S414) are handled by the disaster roaming service controller (140).

At S402, the method includes detecting the disaster condition associated with the first PLMN (200a). The first PLMN (200a) is associated with the first service provider. At S404, the method includes sending the registration request to the second PLMN (200b) for the disaster roaming service. The second PLMN (200b) is associated with the second service provider and is available in the disaster area covered by the first PLMN (200a).

At S406, the method includes receiving the TAI list from the second PLMN (200b) in response to the registration request, in a NAS message, registration accept. The TAI list includes the set of tracking areas associated with the disaster area covered by the second PLMN (200b). At S408, the method includes camping on the second PLMN (200b) for the disaster roaming service in the set of tracking areas indicated in the TAI list during the disaster condition with the first PLMN (200a).

At S410, the method includes receiving the change in the disaster area detected by the second PLMN (200b). At S412, the method includes receiving the updated TAI list from the second PLMN (200b), in a NAS message, Configuration update command. The updated TAI list includes an updated set of tracking areas with the disaster condition covered by the second PLMN (200b). At S414, the method includes camping on the second PLMN (200b) for the disaster roaming service in the updated set of tracking areas indicated in the updated TAI list during the disaster condition with the first PLMN (200a).

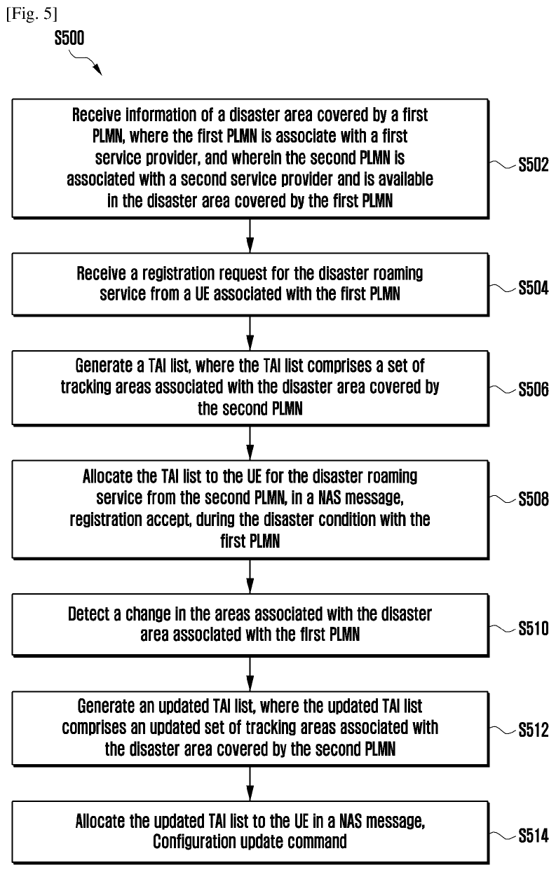

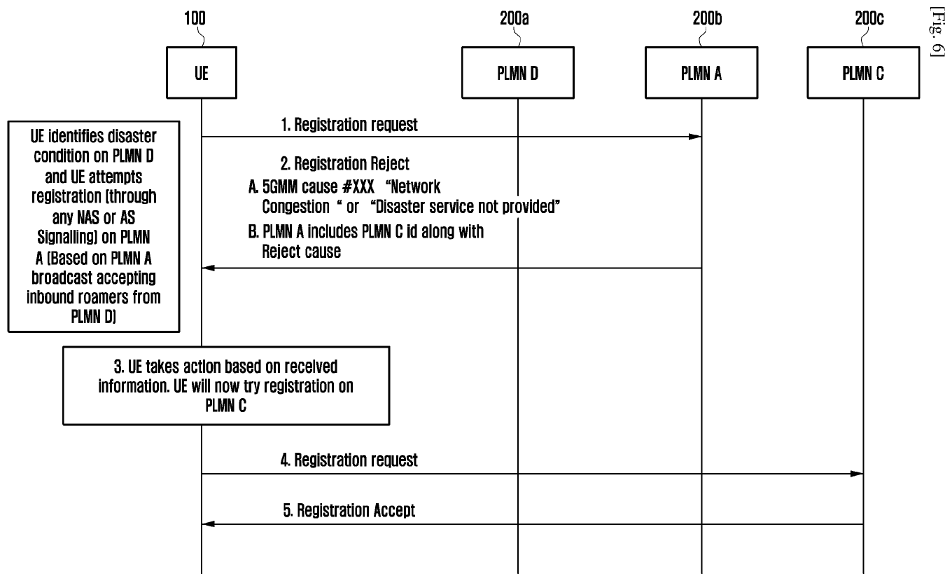

FIG. 5 is a flow chart (S500) illustrating a method, implemented by the PLMN (200), for controlling the disaster area for the disaster roaming service in the wireless network (1000), according to an embodiment as disclosed herein. The operations (S502-S514) are handled by the disaster roaming service controller (240).

At S502, the method includes receiving information of the disaster area covered by the first PLMN (200a). The first PLMN (200a) is associated with the first service provider. The second PLMN (200b) is associated with the second service provider and is available in the disaster area covered by the first PLMN (200a). At S504, the method includes receiving the registration request for the disaster roaming service from the UE (100) associated with the first PLMN (200a). At S506, the method includes generating the TAI list, where the TAI list includes the set of tracking areas associated with the disaster area covered by the second PLMN (200b). At S508, the method includes allocating the TAI list to the UE (100) for the disaster roaming service from the second PLMN (200b) in a NAS message, registration accept during the disaster condition with the first PLMN (200a).

At S510, the method includes detecting the change in the areas associated with the disaster area associated with the first PLMN (200a). At S512, the method includes generating the updated TAI list, where the updated TAI list comprises an updated set of tracking areas associated with the disaster area covered by the second PLMN (200b). At S514, the method includes allocating the updated TAI list to the UE (100), in a NAS message, Configuration update command.

FIG. 6 is a signaling diagram illustrating a scenario of congestion control in other PLMNs not affected by the disaster method, according to the embodiments as disclosed herein.

Unlike to the conventional methods and systems, referring to the FIG. 6 consider a proposed method, provides congestion control in other PLMNs not affected by disaster scenario as follows:
1. If the inbound roamer attempts registration on the PLMN A (PLMN not affected by disaster and accepting inbound roamers of PLMN D) and if PLMN A is already congested or it determines based on subscription or local configuration or based on information from PLMN D that it should not provide service to the UE (100), then the PLMN A can reject the UE (100) registration through any of the NAS or AS signaling using specific 5GMM cause #XXX “Network Congestion” or “Disaster service not provided”.
2. The PLMN A can also include the target PLMN id (any other PLMN which is not affected by disaster and accepting inbound roamers of PLMN D during disaster OR the VPLMN or the HPLMN) to user along with the reject cause.
3. The PLMN A can also provide estimated non availability duration of this PLMN which provides reject to the UE (100), thus UE should not attempt on this PLMN for provided time duration for disaster bound services. After which UE (100) is allowed to re-attempt registration on the PLMN A.
4. The UE (100) can then prioritize such PLMNs over others and hence reduce the time wasted in attempting other PLMNs which won't provide service to the UE (100). If no PLMN IDs were provided UE (100) should attempt for registration on some other PLMNs to receive “disaster period services”.
5. The congestion on the PLMNs not affected by disaster and accepting inbound roamers of PLMN D could be reduced.
6. The UE (100) would be able to get faster service using the PLMN id included along with the reject cause.

Referring to the FIG. 6, the UE (100) identifies the disaster condition on the PLMN D and the UE (100) attempts registration (through any NAS or AS signaling) on the PLMN A (Based on PLMN A broadcast accepting inbound roamers from the PLMN D). At 1, the UE (100) sends the registration request with the PLMN A. At 2, the PLMN A sends the registration reject to the UE (100). The registration reject includes A) 5GMM cause #XXX “Network Congestion” or “Disaster service not provided” and B) PLMN A includes PLMN C id along with Reject cause. At 3, the UE (100) takes action based on received information. The UE (100) will now try registration on the PLMN C. At 4, the UE (100) sends the registration request with the PLMN C. At 5, the PLMN C sends the registration accept to the UE (100).

FIG. 7 is signaling diagram illustrating a scenario of a VPLMN to provide disaster inbound roamer UE's location to a HPLMN for verification, according to the embodiments as disclosed herein.

As shown in the FIG. 7, the UE (100) identifies disaster condition on the PLMN D and the UE (100) attempts registration (through any NAS or AS signaling) on the PLMN A (Based on PLMN A broadcast accepting inbound roamers from the PLMN D). At 1, the UE (100) sends the registration request to the PLMN A. At 2, the PLMN A sends the UE's location information for verification to the PLMN D. At 3, the PLMN D verifies if the UE (100) is in the disaster area of the PLMN D or not and informs the PLMN A accordingly to the accept/reject registration. At 4, the PLMN A sends the registration accept/reject to the UE (100).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for controlling disaster area for disaster roaming service in a wireless network (1000), wherein the method comprises:
detecting, by a user equipment (UE) (100), a disaster condition associated with a first public land mobile network (PLMN) (200a), wherein the first PLMN (200a) is associated with a first service provider;
sending, by the UE (100), a registration request to a second PLMN (200b) for the disaster roaming service, wherein the second PLMN (200b) is associated with a second service provider and is available in a disaster area covered by the first PLMN (200a);
receiving, by the UE (100), a registration accept including a Tracking Area Identity (TAI) list from the second PLMN (200b) in response to the registration request, wherein the TAI list comprises a set of tracking areas associated with the disaster area covered by the second PLMN (200b); and
camping, by the UE (100), on the second PLMN for the disaster roaming service in the set of tracking areas indicated in the TAI list during the disaster condition with the first PLMN (200a).

2. The method of claim 1, wherein if the registration request to the second PLMN (200b) for the disaster roaming service is received outside disaster area determined by the second PLMN(200b) or the disaster roaming service is not provided to the first PLMN(200a) by second PLMN(200b), the registration request is rejected by the second PLMN (200b) indicating a cause to the UE (100).

3. The method of claim 1, further comprising:
receiving, by the UE (100), a change in the disaster area detected by the second PLMN (200b); and
receiving, by the UE (100), an updated TAI list from the second PLMN (200b), wherein the updated TAI list comprises an updated set of tracking areas with the disaster condition covered by the second PLMN (200b); and
camping, by the UE (100), on the second PLMN (200b) for the disaster roaming service in the updated set of tracking areas indicated in the updated TAI list during the disaster condition with the first PLMN (200a).

4. A method for controlling disaster roaming service in a wireless network (1000), wherein the method comprises:
obtaining, by a second public land mobile network (PLMN) (200b), information on a disaster area covered by a first PLMN (200a), wherein the first PLMN (200a) is associated with a first service provider, and wherein the second PLMN (200b) is associated with a second service provider and is available in the disaster area covered by the first PLMN (200a);
receiving, by the second PLMN (200b), a registration request for the disaster roaming service from a user equipment (UE) (100) associated with the first PLMN(200a);
allocating, by the second PLMN (200b), a Tracking Area Identity (TAI) list, wherein the TAI list comprises a set of tracking areas associated with the disaster area covered by the second PLMN (200b); and
transmitting, by the second PLMN (200b), a registration accept including the TAI list to the UE (100) for providing the disaster roaming service to the UE (100), during the disaster condition with the first PLMN (200a).

5. The method of claim 4, further comprising:
detecting, by the second PLMN (200b), a change in the areas associated with the disaster area associated with the first PLMN (200a);
generating, by the second PLMN (200b), an updated TAI list, wherein the updated TAI list comprises an updated set of tracking areas associated with the disaster area covered by the second PLMN (200b); and
allocating, by the second PLMN (200b), the updated TAI list to the UE (100).

6. The method of claim 4, wherein generating, by the second PLMN (200b), the TAI list comprises:
mapping, by the second PLMN(200b), the disaster area covered by the first PLMN (200a) to Tracking Area Code (TAC) of the second PLMN(200b); and
generating, by the second PLMN (200b), the TAI list based on the mapping.

7. The method of claim 4, wherein if the registration request to the second PLMN (200b) for the disaster roaming service is received outside disaster area determined by the second PLMN (200b) or the disaster roaming service is not provided to the first PLMN (200a) by second PLMN (200b), the registration request is rejected by the second PLMN (200b) indicating a cause to the UE (100).

8. A user equipment (UE) (100) for controlling disaster roaming service in a wireless network (1000), wherein the UE (100) comprises:
a memory (130);
a processor (110); and
a disaster roaming service controller (140), connected to the memory (130) and the processor (110), configured to:
detect a disaster condition associated with a first public land mobile network (PLMN) (200a), wherein the first PLMN (200a) is associated with a first service provider;
send a registration request to a second PLMN (200b) for the disaster roaming service, wherein the second PLMN (200b) is associated with a second service provider and is available in a disaster area covered by the first PLMN (200a);
receive a registration accept including a Tracking Area Identity (TAI) list from a second PLMN (200b) in response to the registration request, wherein the TAI list comprises a set of tracking areas associated with the disaster area covered by the second PLMN (200b); and
camp on the second PLMN (200b) for the disaster roaming service in the set of tracking areas indicated in the TAI list during the disaster condition with the first PLMN (200a).

9. The UE (100) of claim 8, wherein if the registration request to the second PLMN (200b) for the disaster roaming service is received outside disaster area determined by the second PLMN (200b) or the disaster roaming service is not provided to the first PLMN (200a) by second PLMN (200b), the registration request is rejected by the second PLMN (200b) indicating a cause to the UE (100).

10. The UE (100) of claim 8, wherein the disaster roaming service controller (140) is configured to:
receive a change in the disaster area detected by the second PLMN (200b); and
receive an updated TAI list from the second PLMN (200b), wherein the updated TAI list comprises an updated set of tracking areas with the disaster condition covered by the second PLMN (200b); and
camp on the second PLMN (200b) for the disaster roaming service in the updated set of tracking areas indicated in the updated TAI list during the disaster condition with the first PLMN (200a).

11. A second public land mobile network (PLMN) (200b) for controlling disaster roaming service in a wireless network (1000), wherein the second PLMN(200b) comprises:
a memory (230);
a processor (210); and
a disaster roaming service controller (240), connected to the memory (230) and the processor (210), configured to:
obtain information on a disaster area covered by a first PLMN (200a), wherein the first PLMN (200a) is associated with a first service provider, and wherein the second PLMN (200b) is associated with a second service provider and is available in the disaster area covered by the first PLMN (200a);
receive a registration request for the disaster roaming service from a user equipment (UE) (100) associated with the first PLMN(200a);
allocate a Tracking Area Identity (TAI) list, wherein the TAI list comprises a set of tracking areas associated with the disaster area covered by the second PLMN (200b); and
transmit a registration accept including the TAI list to the UE (100) for providing the disaster roaming service to the UE (100) during the disaster condition with the first PLMN (100a).

12. The second PLMN(200b) of claim 11, wherein the disaster roaming service controller (240) is configured to:
detect a change in the areas associated with the disaster area associated with the first PLMN (200a);
generate an updated TAI list, wherein the updated TAI list comprises an updated set of tracking areas associated with the disaster area covered by the second PLMN (200b); and
allocate the updated TAI list to the UE (100).

13. The second PLMN(200b) of claim 11, wherein the generate the TAI list comprises:
map the disaster area covered by the first PLMN (200a) to Tracking Area Code (TAC) of the second PLMN (200b); and
generate the TAI list based on the mapping.

14. The second PLMN (200b) of claim 11, wherein if the registration request to the second PLMN (200b) for the disaster roaming service is received outside disaster area determined by the second PLMN (200b) or the disaster roaming service is not provided to the first PLMN (200a) by second PLMN (200b), the registration request is rejected by the second PLMN (200b) indicating a cause to the UE (100).
